(19) United States
(12) Patent Application Publication
(10) Pub. No.: US 2016/0148186 A1
(43) Pub. Date: May 26, 2016

(54) INFORMATION PROCESSING SYSTEM, CONTROL METHOD OF INFORMATION PROCESSING SYSTEM, AND INFORMATION PROCESSING PROGRAM

(71) Applicant: RAKUTEN, INC., Shinagawa-ku (JP)

(72) Inventor: Hideaki TOBINAI, Shinagawa-ku (JP)

(73) Assignee: RAKUTEN, INC., Shinagawa-ku (JP)

(21) Appl. No.: 14/385,663

(22) PCT Filed: Apr. 30, 2013
(86) PCT No.: PCT/JP2013/062645

§ 371 Date: Sep. 16, 2014

(51) Int. Cl. G06Q 20/28; G06Q 20/10; G06Q 20/22

(52) U.S. Cl. CPC G06Q 20/28; G06Q 20/227; G06Q 20/10

(57) ABSTRACT

An information processing system according to one embodiment includes a determination unit and a changing unit. The determination unit sets a limit amount and a security deposit amount so that the sum of the two amounts does not exceed an amount of advance payment made by a user having applied for a prepaid payment means available at a member shop of a postpaid payment means. The changing unit refers to a pool storage unit that stores a pooled amount to be used for payment for an amount billed for sales from the member shop, and adds the security deposit amount set by the determination unit to the pooled amount. The amount billed exceeds a balance of the prepaid payment means. The pooled amount includes a security deposit of another user different from the user.

### TECHNICAL FIELD

One aspect of the present invention relates to an information processing system, a control method of an information processing system, and an information processing program for managing ID information of a prepaid payment means.

### BACKGROUND ART

Prepaid payment means such as a prepaid card have been widely used, including a prepaid card that can be used in the same manner as a credit card at a member shop of the credit card. Further, a server controlled payment system that, when the balance of a prepaid card that doubles as a credit card is lower than the payment amount, calculates the balance due and pays the calculated balance due with the credit card is disclosed in the following Patent Literature 1.

### CITATION LIST

### Patent Literature

PTL 1: JP 2004-171527 A

### SUMMARY OF INVENTION

### Technical Problem

In credit card settlement, there is a case where a card company is billed for the amount of sales which is larger than the amount when credit inquiry is made from a member shop. For example, when a user has used a credit card at an overseas member shop, there is a possibility that the amount to be paid from the card company to the member shop exceeds the amount of purchase presented to the user at the time of credit inquiry due to fluctuations in exchange that have occurred between the credit inquiry at the member shop and the sales billing from the member shop. Further, when a user uses a credit card as a means of monthly fee withdrawal, there is a case where credit inquiry is made only at the time of initial registration and not made at the time of monthly payment. However, the card company cannot reject the sales billing from the member shop related to the valid credit card as a rule and needs to pay the billed amount to the member shop.

In the case of a credit card, a card company conducts sufficient identification during membership examination at the time of new card issuance. Thus, the card company can collect the money for the shortfall related to the sales billing with no verification of credit inquiry from the user with some time and work.

On the other hand, in the case of a prepaid payment means (physical or virtual prepaid card) that uses the scheme of a credit card, a card company does not conduct sufficient identification at the time of new card issuance in many cases. Thus, when a card company is billed for the amount exceeding the balance of the prepaid card, it is extremely difficult for the card company to collect the money corresponding to the shortfall covered by the company from the user.

Accordingly, it is desirable to reduce the risk of a loss to an issuer of a prepaid payment means that uses the scheme of a credit card.

### Solution to Problem

An information processing system according to one aspect of the present invention is an information processing system capable of reflecting setting and change of data on a storage unit accessed by a payment processing device having a function of transmitting approval information only when an inquiry amount contained in inquiry information transmitted from a terminal located in a credit card member shop is equal to or less than an available amount specified from data stored in the storage unit in association with ID information corresponding to a payer related to the inquiry information, a function of changing data stored in the storage unit so that the inquiry amount is reduced from the available amount when the approval information is transmitted, and a function of performing payment processing for paying funds collected from a user corresponding to the ID information to the member shop based on sales information from the member shop, the system including a setting unit configured to store data for specifying an initial available amount which is set so as not to exceed an amount of advance payment made in association with an issuance application for a prepaid payment means available at the member shop into the storage unit in association with ID information of the prepaid payment means corresponding to the issuance application, a determination unit configured to determine a security deposit amount so that the security deposit amount does not exceed a balance of the available amount corresponding to the prepaid payment means, and a changing unit configured to change data stored in the storage unit so that the determined security deposit amount is not included in the balance of the available amount, and change a pooled amount so that the determined security deposit amount is included in the pooled amount indicating an accumulated amount of security deposits to be used as funds to make up a loss occurring due to that at least a part of an amount billed contained in the sales information has not been approved in advance in payment processing related to any prepaid payment means.

A control method of an information processing system according to one aspect of the present invention causes one or a plurality of computers constituting an information processing system capable of reflecting setting and change of data on a storage unit accessed by a payment processing device having a function of transmitting approval information only when an inquiry amount contained in inquiry information transmitted from a terminal located in a credit card member shop is equal to or less than an available amount specified from data stored in the storage unit in association with ID information corresponding to a payer related to the inquiry information, a function of changing data stored in the storage unit so that the inquiry amount is reduced from the available amount when the approval information is transmitted, and a function of performing payment processing for paying funds collected from a user corresponding to the ID information to the member shop based on sales information from the member shop to execute setting processing to store data for specifying an initial available amount which is set so as not to exceed an amount of advance payment made in association with an issuance application for a prepaid payment means available at the member shop into the storage unit in association with ID information of the prepaid payment means corresponding to the issuance application, determination processing to determine a security deposit amount so that the security deposit amount does not exceed a balance of the available amount corresponding to the prepaid payment means, and changing processing to change data stored in the storage unit so that the determined security deposit amount is not included in the balance of the available amount, and change a pooled amount so that the determined security deposit amount is included in the pooled amount indicating an accumulated amount of security deposits to be used as funds to make up a loss occurring due to that at least a part of an amount billed contained in the sales information has not been approved in advance in payment processing related to any prepaid payment means.

An information processing program according to one aspect of the present invention causes one or a plurality of computers constituting an information processing system capable of reflecting setting and change of data on a storage unit accessed by a payment processing device having a function of transmitting approval information only when an inquiry amount contained in inquiry information transmitted from a terminal located in a credit card member shop is equal to or less than an available amount specified from data stored in the storage unit in association with ID information corresponding to a payer related to the inquiry information, a function of changing data stored in the storage unit so that the inquiry amount is reduced from the available amount when the approval information is transmitted, and a function of performing payment processing for paying funds collected from a user corresponding to the ID information to the member shop based on sales information from the member shop to implement, as functions, a setting unit configured to store data for specifying an initial available amount which is set so as not to exceed an amount of advance payment made in association with an issuance application for a prepaid payment means available at the member shop into the storage unit in association with ID information of the prepaid payment means corresponding to the issuance application, a determination unit configured to determine a security deposit amount so that the security deposit amount does not exceed a balance of the available amount corresponding to the prepaid payment means, and a changing unit configured to change data stored in the storage unit so that the determined security deposit amount is not included in the balance of the available amount, and change a pooled amount so that the determined security deposit amount is included in the pooled amount indicating an accumulated amount of security deposits to be used as funds to make up a loss occurring due to that at least a part of an amount billed contained in the sales information has not been approved in advance in payment processing related to any prepaid payment means.

A computer-readable recording medium according to one aspect of the present invention stores an information processing program causing one or a plurality of computers constituting an information processing system capable of reflecting setting and change of data on a storage unit accessed by a payment processing device having a function of transmitting approval information only when an inquiry amount contained in inquiry information transmitted from a terminal located in a credit card member shop is equal to or less than an available amount specified from data stored in the storage unit in association with ID information corresponding to a payer related to the inquiry information, a function of changing data stored in the storage unit so that the inquiry amount is reduced from the available amount when the approval information is transmitted, and a function of performing payment processing for paying funds collected from a user corresponding to the ID information to the member shop based on sales information from the member shop to implement, as functions, a setting unit configured to store data for specifying an initial available amount which is set so as not to exceed an amount of advance payment made in association with an issuance application for a prepaid payment means available at the member shop into the storage unit in association with ID information of the prepaid payment means corresponding to the issuance application, a determination unit configured to determine a security deposit amount so that the security deposit amount does not exceed a balance of the available amount corresponding to the prepaid payment means, and a changing unit configured to change data stored in the storage unit so that the determined security deposit amount is not included in the balance of the available amount, and change a pooled amount so that the determined security deposit amount is included in the pooled amount indicating an accumulated amount of security deposits to be used as funds to make up a loss occurring due to that at least a part of an amount billed contained in the sales information has not been approved in advance in payment processing related to any prepaid payment means.

In the above aspect, a part of the advance payment made for application of a prepaid payment means is kept as the security deposit. Thus, an issuer of the prepaid payment means can use the security deposit as a fund for payment for billing for sales exceeding the balance. It is thereby possible to reduce the risk of a loss to an issuer of a prepaid payment means that uses the scheme of a credit card.

In the information processing system according to another aspect, the determination unit may determine the security deposit amount after the prepaid payment means is used at least once at any member shop.

In the information processing system according to another aspect, the determination unit may determine the security deposit amount each time the balance of the available amount varies, and the changing unit may change the pooled amount and the data stored in the storage unit each time the security deposit amount is determined.

In the information processing system according to another aspect, the determination unit may increase the security deposit amount each time the balance of the available amount decreases.

In the information processing system according to another aspect, the setting unit may further change the data stored in the storage unit so that an amount of advance payment made in association with an application for an increase in the available amount is added to the balance of the available amount, and the determination unit may decrease the security deposit amount each time the balance of the available amount increases.

In the information processing system according to another aspect, when a balance not used to make up a loss caused by payment processing of a first prepaid payment means remains in a security deposit corresponding to the first prepaid payment means, the setting unit may further store an initial available amount which is set so as not to exceed an amount obtained by at least adding the balance of the security deposit corresponding to the first prepaid payment means to an amount of advance payment made in association with a transfer issuance application for a prepaid payment means by a user of the first prepaid payment means into the storage unit in association with ID information of a second prepaid payment means corresponding to the transfer issuance application.

In the information processing system according to another aspect, when there is a history indicating use of the first prepaid payment means at a member shop with a history of transmitting sales information for billing an amount exceeding an approved amount, the setting unit may subtract a specified amount from the balance of the security deposit of the first prepaid payment means to be added to the amount of advance payment made in association with the transfer issuance application.

In the information processing system according to another aspect, when it is evaluated that a possibility of occurrence of the loss is low in payment processing of the prepaid payment means, the determination unit may reduce or exempt the security deposit to be set for the prepaid payment means.

The information processing system according to another aspect may further include an evaluation unit configured to evaluate that a possibility of occurrence of the loss is low in payment processing of the prepaid payment means when another payment means different from the prepaid payment means is stored in the storage unit in association with the ID information.

In the information processing system according to another aspect, the evaluation unit may evaluate that the possibility is low when a postpaid payment means is stored as said another payment means, and the determination unit may exempt the security deposit when it is evaluated that the possibility is low.

The information processing system according to another aspect may further include an evaluation unit configured to evaluate that a possibility of occurrence of the loss is low in payment processing of the prepaid payment means when the prepaid payment means is a payment means requiring credit inquiry at the member shop each time payment is made.

### Advantageous Effects of Invention

According to one aspect of the present invention, it is possible to reduce the risk of a loss to an issuer of a prepaid payment means that uses the scheme of a credit card.

### BRIEF DESCRIPTION OF DRAWINGS

FIG. 1 is a diagram showing a concept of setting a prepaid card according to an embodiment.

FIG. 2 is a diagram showing an overall configuration of an ID management system according to an embodiment.

FIG. 3 is a diagram showing an example of a card database.

FIG. 4 is a diagram showing an example of a pool database.

FIG. 5 is a diagram showing an example of a use history database.

FIG. 6 is a diagram showing a hardware configuration of an ID management device according to an embodiment.

FIG. 7 is a diagram showing a functional configuration of an ID management device according to an embodiment.

FIG. 8 is a diagram showing an example of changing a security deposit.

FIG. 9 is a flowchart showing processing of an ID management device according to an embodiment.

FIG. 10 is a diagram showing an example of transfer to a new prepaid card.

FIG. 11 is a flowchart showing a method of determining a security deposit amount and a limit amount at the time of transfer to a new prepaid card.

FIG. 12 is a diagram showing a configuration of an ID management program according to an embodiment.

### DESCRIPTION OF EMBODIMENTS

Embodiments of the present invention are described hereinafter in detail with reference to the appended drawings. Note that, in the description of the drawings, the same or equivalent elements are denoted by the same reference symbols, and the redundant explanation thereof is omitted.

An ID management system 1 is an information processing system that manages a prepaid card and, more specifically, performs initial issuance, transfer issuance, setting change and the like of the card.

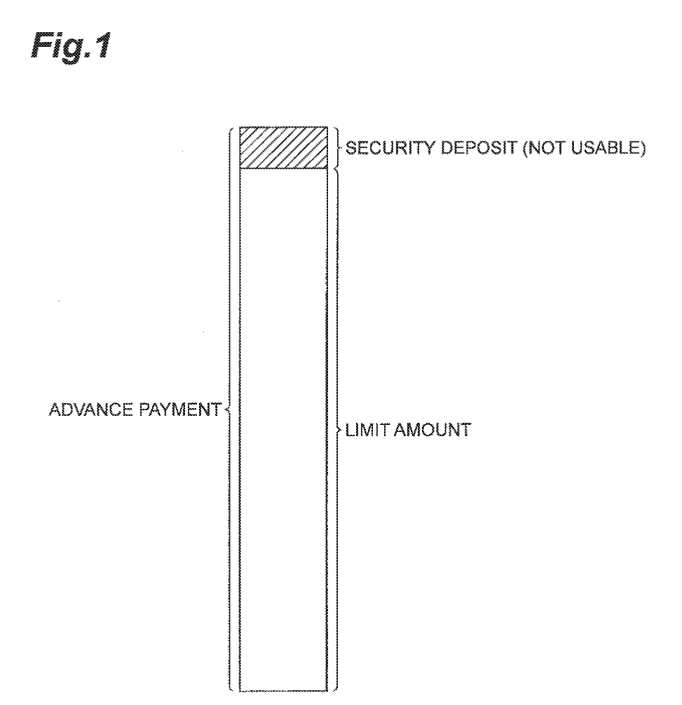

A user makes advance payment for using a prepaid card and then obtains a prepaid card where the amount remaining after subtracting a security deposit (initial security deposit) from the advance payment amount is set as a limit amount (initial available amount; credit line). FIG. 1 shows the concept of this setting. Each user can use a prepaid card only within the limit amount. On the other hand, a card company keeps the deposit.

The prepaid card is a prepaid payment means that uses the scheme of a credit card and has the same card information (a card number, an expiration date and a security code) as a credit card. The prepaid card is not a physical card but a virtual card (virtual prepaid card) whose card information only is notified to a user. The user can use the prepaid card at a credit card member shop that opens online in the same manner as the credit card.

As described earlier, in the case of fluctuations in exchange or payment on term, although there is a possibility that a card company is billed for the amount exceeding the amount approved by credit inquiry or the amount exceeding the balance of a prepaid card (the balance within the credit line), it is extremely difficult to bill the user for the shortfall. In view of this, the card company keeps a security deposit received from an applicant for a prepaid card and uses the pooled security deposit for the shortfall.

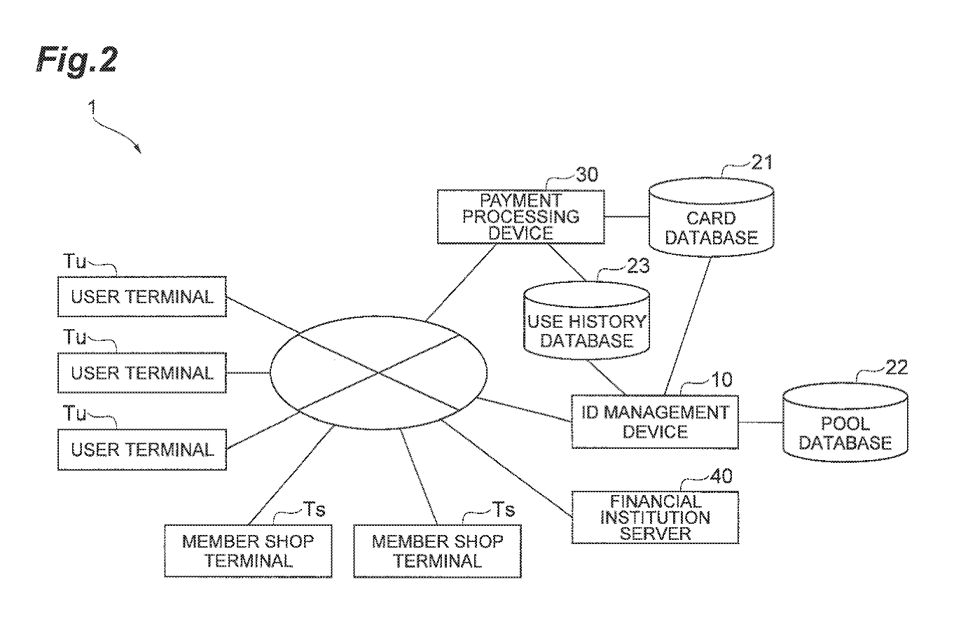

As shown in FIG. 2, the ID management system 1 includes user terminals Tu, an ID management device 10, a card database (storage unit) 21, pool database 22, a use history database 23, member shop terminals Ts, a payment processing device 30, and a financial institution server 40.

The user terminals Tu, the ID management device 10 and the financial institution server 40 are connected with one another through a network such as the Internet. The member shop terminals Ts and the payment processing device 30 are connected with one another through a network such as the Internet or a private line. The ID management device 10 and the payment processing device 30 can directly or indirectly access the card database 21 and the use history database 23 through a network such as the Internet or a private line. The ID management device 10 can further directly or indirectly access the pool database 22 through such a network. The card database 21 and the use history database 23 may be composed of a plurality of storage devices having the function of maintaining synchronization with each other. Note that the number of user terminals Tu and member shop terminals Ts in the ID management system 1 is not limited.

The user terminal Tu is a terminal that is used by a user who applies for or holds a prepaid card. The variety of the user terminals Tu is not particularly limited, and it may be a stationary or portable personal computer, or a mobile terminal such as an advanced mobile phone (smart phone), a cellular phone or a personal digital assistant (PDA), for example.

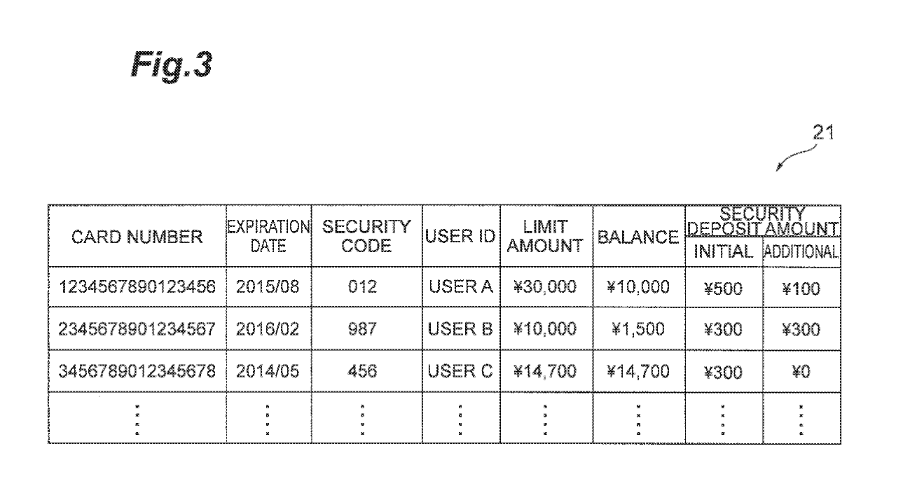

The card database 21 is a device that stores card information. The card information is information about a card number that is assigned to a user, and each record of the card information is identified by the card number. As shown in FIG. 3, each record contains the following items. In this specification, the card number corresponds to ID information.
Number (“card number”) of the prepaid card
“Expiration date” of the prepaid card
“Security code” of the prepaid card
“User ID” that uniquely identifies a user
“Limit amount” of the prepaid card
“Balance” of the prepaid card
“Security deposit” kept by a card company. The security deposit amount is the sum of the initial security deposit amount and the additional security deposit amount.

Note that the card database 21 may store the card information (a card number, an expiration date, a security code, a limit amount, an expended amount etc.) of a credit card in addition to the information of the prepaid card.

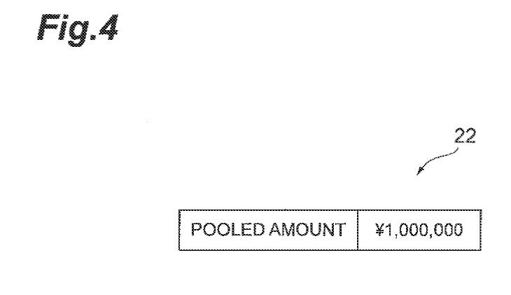

The pool database 22 is a device that stores the total amount of security deposits collected from the users (the amount of pooled security deposits). FIG. 4 shows an example of the configuration of the pool database 22. When a loss arises due to the fact that at least a part of the amount billed contained in sales information has not been approved in advance in payment processing for a prepaid card, the accumulated security deposits are used as funds to make up the loss.

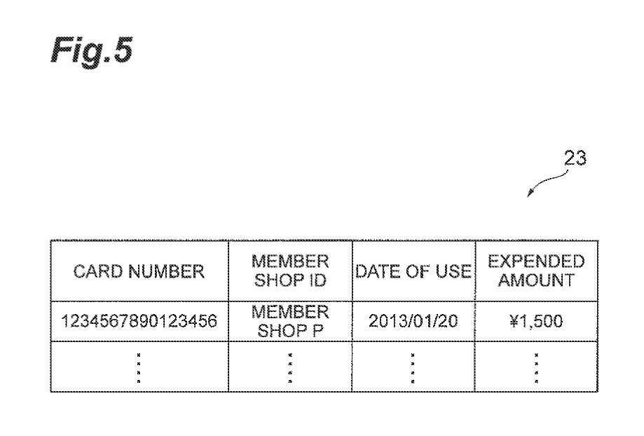

The use history database 23 is a device that stores the use history of a prepaid card. As shown in FIG. 5, each record of the use history contains a card number, a member shop ID that uniquely identifies a member shop, the date of use and the expended amount of the prepaid card. The use history may contain another information.

Note that the configuration of each database is not limited. For example, another information may be added to the card information, and the card information or the use history may be normalized or made redundant by an arbitrary policy. If the ID management device 10 obtains the pooled amount by calculating the total amount of the initial security deposit and the additional security deposit in the card database 21, the pool database 22 can be omitted.

The member shop terminal Ts is a terminal for making a payment with a credit card or a prepaid card, and it is located at a member shop of the credit card. The member shop terminal Ts executes payment processing in coordination with the payment processing device 30.

The payment processing device 30 is a computer that executes payment processing for a credit card or a prepaid card. The payment processing device 30 has the following functions.
Function of transmitting approval information only when the inquiry amount contained in inquiry information transmitted from the member shop terminal Ts is equal to or less than the available amount (balance) specified from the data stored in the card database 21 in association with the card number corresponding to a payer related to the inquiry information. The approval information may be transmitted only when the inquiry amount is equal to or less than the available amount and the card number is valid.
Function of changing the data stored in the card database 21 so that the inquiry amount is reduced from the available amount when the approval information is transmitted. At this time, the payment processing device 30 generates a record of the use history and stores the record into the use history database 23.
Function of performing payment processing for paying funds collected from a user corresponding to the card number to a member shop based on sales information from the member shop.

The financial institution server 40 is a computer that executes processing for advance payment that is made for a user to use a prepaid card. The variety of the financial institution is not particularly limited, and it may be a bank, an electronic money management company and the like, for example. Further, a method of advance payment and payment processing is not particularly limited. For example, a user may make payment by using one or a plurality of points for advance payment.

The ID management device 10 is a computer that manages a prepaid card. The ID management device 10 can reflect setting and change of data on the card database 21.

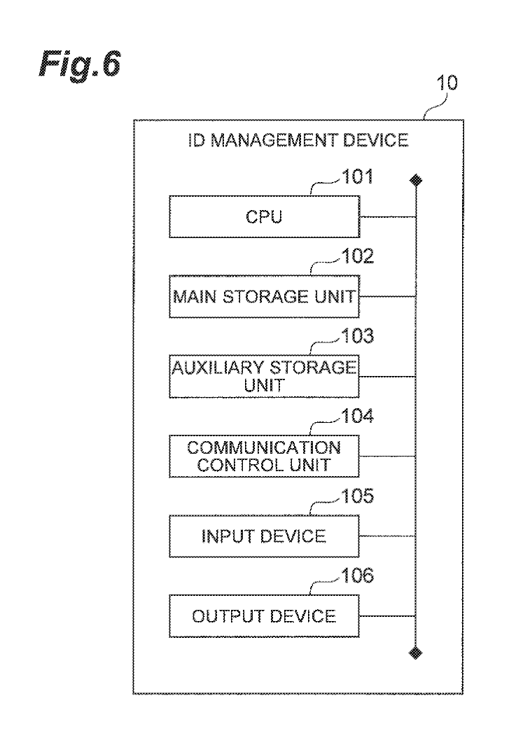

FIG. 6 shows a hardware configuration of the ID management device 10. The ID management device 10 includes one or more CPU 101 that executes an operating system, an application program and the like, a main storage unit 102 such as ROM and RAM, an auxiliary storage unit 103 such as a hard disk and a flash memory, a communication control unit 104 such as a network card or a wireless communication module, an input device 105 such as a keyboard and a mouse, and an output device 106 such as a display.

The functional components of the ID management device 10, which are described later, are implemented by loading given software onto the CPU 101 or the main storage unit 102, making the communication control unit 104, the input device 105, the output device 106 and the like operate under control of the CPU 101, and performing reading and writing of data in the main storage unit 102 or the auxiliary storage unit 103. The data and database required for processing are stored in the main storage unit 102 or the auxiliary storage unit 103.

Although the ID management device 10 is composed of one computer in the example of FIG. 6, the ID management device 10 may be composed of a plurality of computers.

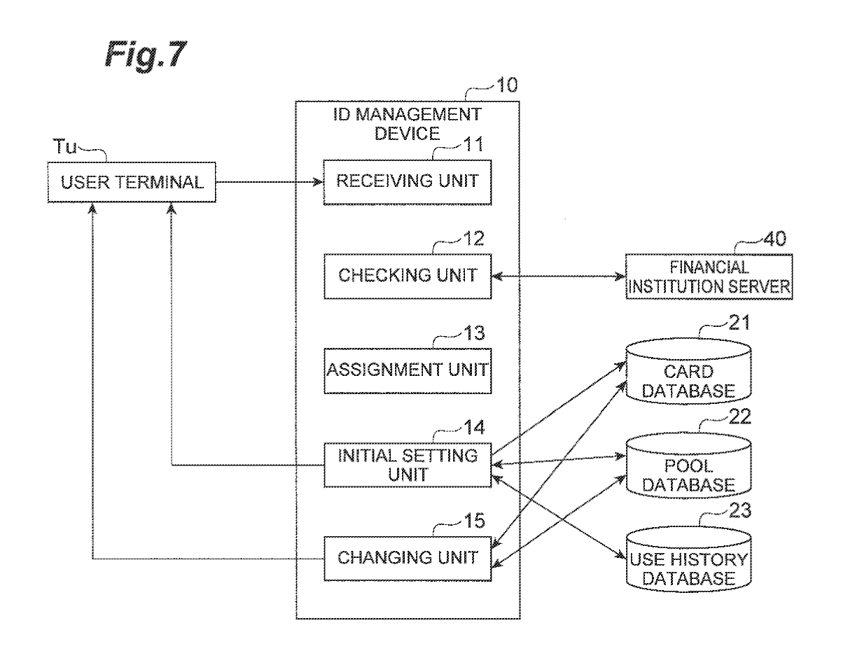

As shown in FIG. 7, the ID management device 10 includes a receiving unit 11, a checking unit 12, an assignment unit 13, an initial setting unit (a setting unit, a determination unit, a changing unit and an evaluation unit) 14, and a changing unit (a determination unit, a changing unit and an evaluation unit) 15 as functional components.

The functions of the ID management device 10 are described as two embodiments hereinbelow. In a first embodiment, a case where a user who does not have a prepaid card applies for a prepaid card for the first time is described. In a second embodiment, a case where a user who already has a prepaid card applies for a new prepaid card is described. The ID management device 10 may be able to execute both of the first and second embodiments or execute the first embodiment only.

### First Embodiment

The receiving unit 11 is a functional component that receives an application for issuance of a prepaid card. The receiving unit 11 may receive information indicating the application for issuance (application information) from the user terminal Tu or receive application information entered by an operator of the ID management device 10 who has received the application from a user. The application information at least contains information for identifying a person (such as a name, a date of birth and contact information (e.g. an address, a phone number, an email address etc.), for example). The receiving unit 11 outputs the application information to the checking unit 12.

The checking unit 12 is a functional component that checks the amount of advance payment that has been made in association with the application. A user makes advance payment to a financial institution by an arbitrary method such as bank transfer. The checking unit 12 inquires the financial institution server 40 about the amount of advance payment by the user and receives information about the amount from the financial institution server 40. The information at least contains information that identifies the user and the amount of advance payment. The checking unit 12 outputs the information as advance payment information, together with the application information, to the initial setting unit 14.

The assignment unit 13 is a functional component that assigns one card number to an application. The assignment unit 13 generates a card number to be issued for an applicant and sets attached information necessary for use of the prepaid card. Although the attached information contains an expiration date and a security code in this specification, the attached information is not limited thereto. The assignment unit 13 outputs the card number and the attached information, together with the application information, to the initial setting unit 14.

The initial setting unit 14 is a functional component that sets the limit amount and the initial security deposit amount corresponding to the card number. The initial setting unit 14 sets the value remaining after subtracting a specified security deposit amount from the advance payment amount as the limit amount.

A method of determining the initial security deposit amount is arbitrary. For example, the security deposit amount may be fixed regardless of the advance payment amount or may be the amount corresponding to a certain percentage of the limit amount (x % of the limit amount).

Alternatively, the initial setting unit 14 may evaluate whether the amount of shortfall exceeding the balance of the prepaid card can be charged to a user and, when it is evaluated that the shortfall is chargeable, set a lower security deposit amount than when it is evaluated that the shortfall is not chargeable. “Set a lower security deposit amount” includes setting the security deposit amount to ¥0, i.e., exempting a user from the security deposit.

For example, if the initial setting unit 14 can obtain information about another payment means of a user, the initial setting unit 14 can set a lower security deposit amount than when it cannot obtain the information. The information about another payment means is information that is used for the ID management device 10 or a card company to collect the amount of shortfall exceeding the balance of the prepaid card from the user. Examples of this information include information about the credit card (postpaid payment means) or the account of the user, contact information for billing and the like, though not limited thereto. The initial setting unit 14 can determine whether a user has another payment means or not by referring to the application information or making inquiries to another card company or financial institution server.

In this manner, by evaluating whether the shortfall can be charged to a user and setting the security deposit amount according to the result, it is possible to set the security deposit amount flexibly for each user according to the possibility that the shortfall occurs or the time and work that are required to collect the shortfall. Because an inconvenience caused to a user becomes large when the security deposit amount is large, a balance between “possible risk or required time and work” and “inconvenience to a user” is achieved in this embodiment.

After determining the initial security deposit amount and the limit amount, the initial setting unit 14 generates card information and stores it into the card database 21. The initial setting unit 14 sets a card number, attached information (an expiration date and a security code) and a user ID based on the input information and sets the determined limit amount and the initial security deposit amount as the corresponding information. The initial setting unit 14 sets the determined limit amount also as the balance. At this point of time, the additional security deposit is 0. Further, the initial setting unit 14 performs processing of adding the determined security deposit amount to the pooled amount on the pool database 22.

By completing those database operations, a prepaid card is virtually issued and becomes usable. If the application information contains an email address of an applicant, the initial setting unit 14 may notify the issuance to the user by email or the like. Alternatively, an operator of the ID management device 10 may notify the issuance to the applicant.

The changing unit 15 is a functional unit that changes the security deposit amount of a prepaid card after the prepaid card becomes usable or after the prepaid card is used at least once at any member shop. Because the security deposit amount varies so as not to exceed the advance payment, a change in the security deposit amount leads to a change in the balance of the prepaid card. A method of changing the security deposit amount is not limited and various methods can be used as follows.

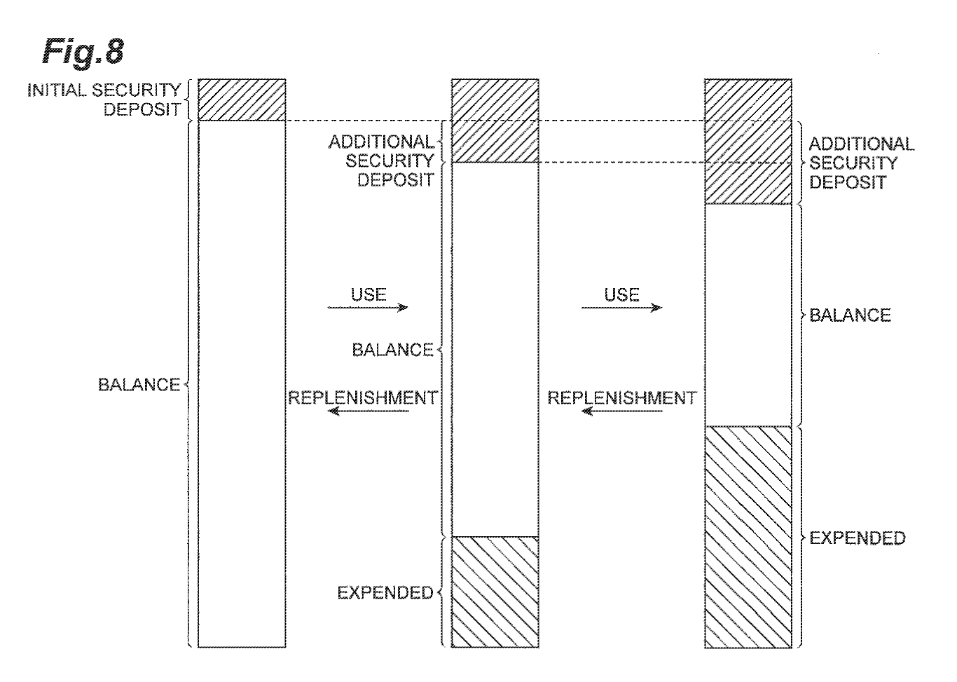

The changing unit 15 may change the security deposit amount in accordance with a variation in the balance. For example, as shown in FIG. 8, the changing unit 15 may increase the security deposit amount with a decrease in the balance and decrease the security deposit amount with an increase in the balance by replenishment of money which does not exceed the limit amount (application for an increased amount). When the balance decreases, the changing unit 15 determines the additional security deposit amount so that the additional security deposit amount does not exceed the changed balance and thereby increases the security deposit amount as a whole. On the other hand, when the balance increases because of replenishment (charging), the changing unit 15 reduces the additional security deposit amount and thereby decreases the security deposit amount as a whole. The lower limit of the whole security deposit amount is the initial security deposit amount.

In one aspect, as the balance becomes smaller, the possibility of occurrence of shortfall in fluctuations in exchange, payment on term or the like increases. It is thus expected to reduce the risk on a card company by keeping a larger security deposit amount according to a decrease in the balance.

Alternatively, the changing unit 15 may decrease the security deposit amount according to a decrease in the balance and increase the security deposit amount according to an increase in the balance by replenishment of money which does not exceed the limit amount. In this case, the changing unit 15 may set the amount corresponding to a certain percentage of the balance (the amount corresponding to x % of the limit amount) as the updated security deposit amount. In this processing, the changing unit 15 may set a certain percentage of the balance as the security deposit on condition that the lower limit of the security deposit amount is the initial security deposit amount. This processing also corresponds to determining the additional security deposit amount.

In one aspect, each expended amount of a prepaid card increases as the balance is larger, and a variation due to fluctuations in exchange, for example, increases accordingly. It is thus expected to reduce the risk on a card company by keeping a larger security deposit amount as the balance is larger.

Alternatively, the changing unit 15 may evaluate whether the amount of shortfall exceeding the balance of the prepaid card can be charged to a user after the issuance of the prepaid card and, when it is evaluated that the shortfall is chargeable, the changing unit 15 may set a lower security deposit amount than when it is evaluated that the shortfall is not chargeable. For example, if the changing unit 15 can obtain information about another payment means of a user, it can set a lower security deposit amount than when it cannot obtain the information. The changing unit 15 can evaluate whether a user has another payment means by making inquiries to another card company or financial institution server on a regular basis, for example.

In this manner, by evaluating whether the shortfall can be charged to a user and setting the security deposit amount according to the result, it is possible to set the security deposit amount flexibly for each user according to the possibility that the shortfall occurs or the time and work that are required to collect the shortfall. By setting the amount in this way, a balance between “possible risk or required time and work” and “inconvenience to a user” is achieved.

After changing the balance and the security deposit amount as described above, the changing unit 15 updates the card information in the card database 21 to the value after change, and increases or decreases the pooled amount in the pool database 22 according to the amount of change in the security deposit. The changing unit 15 may carry out the above-described change processing each time a record is stored in the use history table (each time the balance is changed) for a card number corresponding to the record or may carry out the change processing on a regular basis (for example, once a day).

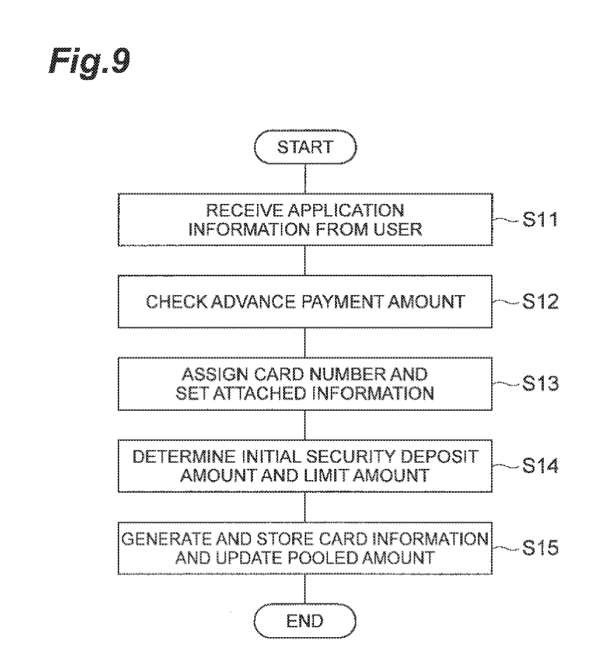

The operation of the ID management device 10 is described and further an information processing method (a control method of an information processing system) according to this embodiment is described hereinafter with reference to FIG. 9.

First, the receiving unit 11 receives application information according to an application from a user (an applicant for a prepaid card) (Steps S11). Next, the checking unit 12 makes inquiry to the financial institution server 40 and checks the advance payment amount (Step S12). Then, the assignment unit 13 assigns a card number and sets attached information (an expiration date and a security code) (Step S13; setting processing). After that, the initial setting unit 14 determines the initial security deposit amount and the limit amount for the prepaid card based on the advance payment (Step S14; determination processing). Then, the initial setting unit 14 generates card information for the card number and stores it into the card database 21 and further updates the pooled amount in the pool database 22 (Step S15; change processing). The security deposit amount for the prepaid card issued by the above process can be changed by the changing unit 15 as described above (change processing).

As described above, according to this embodiment, a part of the advance payment made for an application for a prepaid card is kept as the security deposit. Thus, an issuer of the prepaid card (a card company) can use the security deposit as a fund for payment for the billing for sales exceeding the balance. It is thereby possible to reduce the risk of a loss to an issuer of a prepaid card that uses the scheme of a credit card.

### Second Embodiment

Differences from the first embodiment are particularly described below. A prepaid card already held by a user is referred to as a “current prepaid card” (first prepaid payment means) and a prepaid card related to a new application is referred to as a “new prepaid card” (second prepaid payment means).

The receiving unit 11 receives an application for a new prepaid card (transfer issuance application). The checking unit 12 checks the amount of advance payment that has been made in association with the application (advance payment for the new prepaid card). The assignment unit 13 newly assigns one card number to the application (a number of the new prepaid card) and sets new attached information corresponding to the card number. The functions of the receiving unit 11, the checking unit 12 and the assignment unit 13 are the same as those of the first embodiment.

The initial setting unit 14 sets the limit amount and the initial security deposit amount corresponding to the newly assigned card number. In this processing, the initial setting unit 14 transfers the contents of the current prepaid card into the new prepaid card.

First, the initial setting unit 14 determines a provisional initial security deposit amount Dp for the current advance payment amount and determines the value remaining after subtracting the security deposit amount Dp from the advance payment amount as a provisional limit amount Lp. A method of determining the provisional value is the same as shown in the first embodiment.

Next, the initial setting unit 14 reads the card information corresponding to the user ID contained in the application information (the card information of the current prepaid card) from the card database 21 and acquires the initial security deposit amount Ic, the additional security deposit amount Ac and the balance Bc indicated by the card information.

Then, the initial setting unit 14 transfers the security deposit and the balance of the current prepaid card to the new prepaid card. A method of transferring those information is not limited, and various methods can be used as follows.

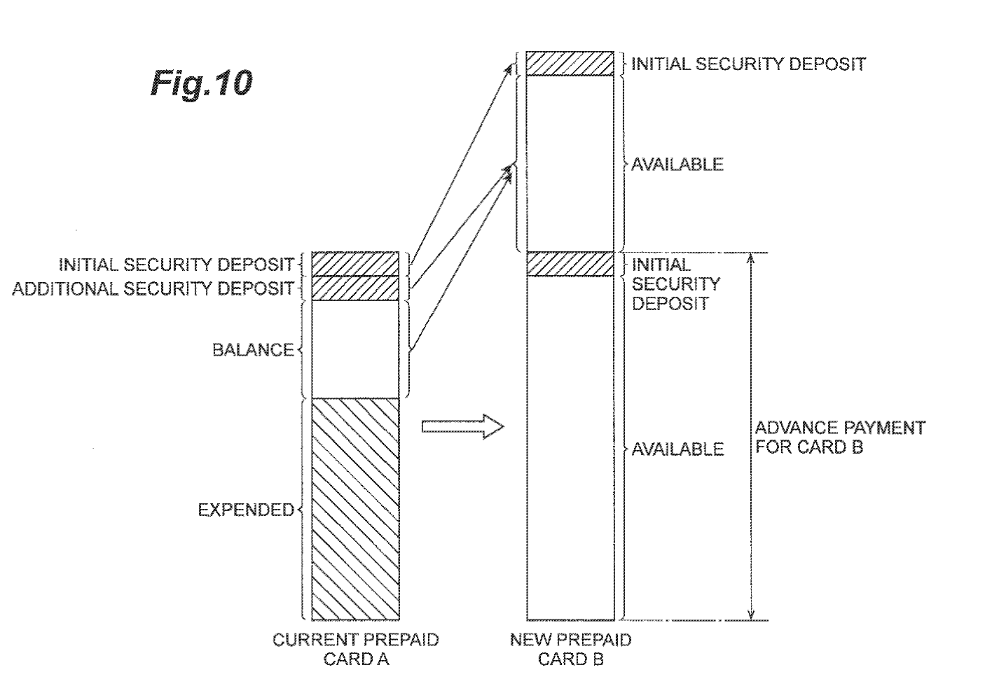

For example, the initial setting unit 14 may set the sum total of the provisional limit amount Lp, the current balance Bc, and at least a part of the current additional security deposit amount Ac as the final use limit, and sets the sum total of the provisional initial security deposit amount Dp and the remainder of the current security deposit amount (Ic+Ac) as the final initial security deposit amount. FIG. 10 shows an example of this processing. In this example, while the whole of the additional security deposit amount Ac is set to be usable in the new prepaid card, the current initial security deposit amount Ic is set to a part of the security deposit of the new prepaid card.

Alternatively, the initial setting unit 14 may set the sum total of the provisional limit amount Lp, the current balance Bc, the whole of the current additional security deposit amount Ac and at least a part of the current initial security deposit amount Ic as the final use limit, and sets the sum total of the provisional initial security deposit amount Dp and the remainder of the current initial security deposit amount Ic as the final initial security deposit amount.

In this manner, by including at least a part of the security deposit of the current prepaid card into the use limit of the new prepaid card, a user can use a larger amount of money.

Alternatively, the initial setting unit 14 may determine the final initial security deposit amount in accordance with the use status of the current prepaid card. To be specific, the initial setting unit 14 refers to the use history database 23 and acquires the history of the current prepaid card.

Data indicating the use status may be the total number of uses, the frequency of use during a specified period, the expended amount of each time and the like. Further, the initial setting unit 14 may acquire whether the card is used at a specific member shop or not as the use status. The “specific member shop” is a store where the amount of payment exceeding the balance can occur, such as an overseas member shop or a member shop that makes payment processing without credit inquiry or with unsubstantial credit inquiry, for example. An example of the data indicating the use status is not limited thereto.

A method of determining the initial security deposit amount on the basis of the use status is also not limited. For example, the initial setting unit 14 may set a larger initial security deposit amount as the total number of uses is larger, may set a larger initial security deposit amount as the frequency of use is higher, or may set a larger initial security deposit amount as the statistics (for example, the average or the median) of the expended amount is higher. Further, in the case where there is a use history at the above-described specific member shop, the initial setting unit 14 may set a larger initial security deposit amount than in the case where there is no such use history.

Alternatively, the initial setting unit 14 may acquire the above-described use status (the total number of uses, the frequency of use during a specified period, the expended amount of each time, the presence or absence of use at a specific member shop etc.) from the use history of a prepaid card or a credit card of another user and set the initial security deposit amount based on the status as described above.

In this manner, by setting the security deposit amount of a new prepaid card in consideration of the use status of the current prepaid card, it is possible to set the security deposit amount flexibly for each user, as well as reducing the risk of a loss to the card company.

After setting the final limit amount and the initial security deposit amount, the initial setting unit 14 generates card information of the new prepaid card and stores it into the card database 21. The initial setting unit 14 sets a card number, attached information (an expiration date and a security code) and a user ID based on the input information and sets the final limit amount and the initial security deposit amount as the corresponding information. The initial setting unit 14 sets the final limit amount also as the balance. At this point of time, the additional security deposit is 0. Further, the initial setting unit 14 invalidates the card information for the current prepaid card. Furthermore, the initial setting unit 14 updates the pool database 22 by adding or subtracting a difference between the security deposit amount of the current prepaid card and the security deposit amount of the new prepaid card (which is the amount of change in the security deposit amount raised by the transfer of the prepaid card) to or from the pooled amount.

By completing the above update, the next prepaid card is issued and becomes usable, and the current prepaid card becomes invalid. If the application information contains an email address of an applicant, the initial setting unit 14 may send a message indicating that the new prepaid card transferred from the current prepaid card has been issued to the user by email or the like. Alternatively, an operator of the ID management device 10 may notify the issuance of the new prepaid card to the applicant.

The changing unit 15 changes the security deposit and the balance after the new prepaid card becomes usable. A method of this changing is the same as described in the first embodiment.

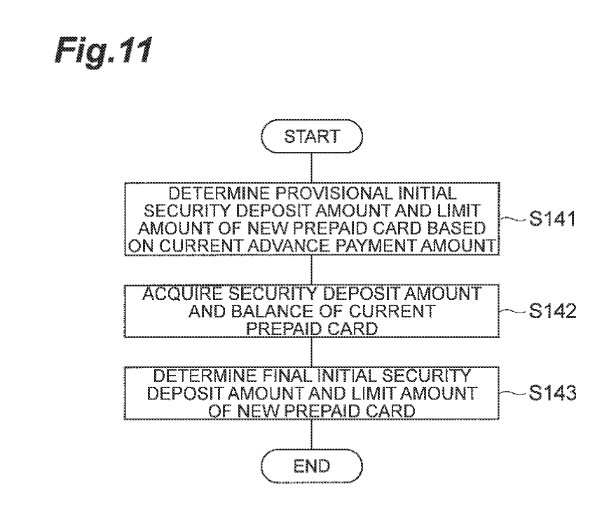

An information processing method (a control method of an information processing system) according to this embodiment is described hereinafter. The processing steps in this embodiment are the same as those in the first embodiment (Steps S11 to S15 described above). The processing of the initial setting unit 14 which is different from that of the first embodiment is described hereinafter with reference to FIG. 11.

In this embodiment, the initial setting unit 14 first determines the provisional initial security deposit amount and the limit amount of the new prepaid card based on the current advance payment amount (Step S141). Next, the initial setting unit 14 reads the card information of the current prepaid card from the card database 21 and thereby acquires the security deposit amount (the initial security deposit amount and the additional security deposit amount) and the balance of the card (Step S142). Then, the initial setting unit 14 determines the final initial security deposit amount and the limit amount of the new prepaid card based on the values obtained in those two steps (Step S143). The initial setting unit 14 can determine the final initial security deposit amount and the limit amount of the new prepaid card by the above-described various methods.

As described above, in this embodiment also, as in the first embodiment, it is possible to reduce the risk of a loss to an issuer of a prepaid card that uses the scheme of a credit card.

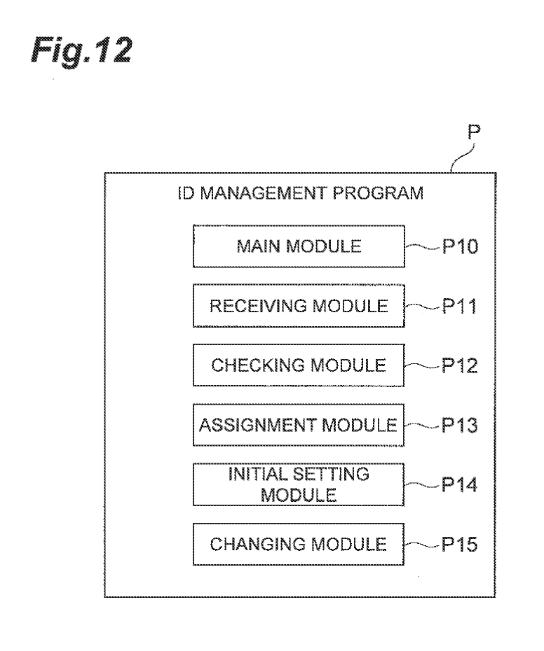

An ID management program (information processing program) P that causes a computer to function as the ID management device 10 according to the first or second embodiment is described hereinafter with reference to FIG. 12.

The ID management program P includes a main module P10, a receiving module P11, a checking module P12, an assignment module P13, an initial setting module P14, and a changing module P15.

The main module P10 is a part that exercises control over the management of a card number. The functions implemented by executing the receiving module P11, the checking module P12, the assignment module P13, the initial setting module P14 and the changing module P15 are equal to the functions of the receiving unit 11, the checking unit 12, the assignment unit 13, the initial setting unit 14 and the changing unit 15 described above, respectively.

The ID management program P is provided in the form of being recorded in a static manner on a tangible recording medium such as CD-ROM or DVD-ROM or semiconductor memory, for example. Further, the ID management program may be provided as a data signal superimposed onto a carrier wave through a communication network.

Hereinbefore, the present invention has been described in detail with respect to the embodiment thereof. However, the present invention is not limited to the above-described embodiment. Various changes and modifications may be made therein without departing from the scope of the invention.

A prepaid payment means may be a payment means that requires credit inquiry at a member shop each time payment is made. In this case, the payment processing device rejects payment without credit inquiry received from a member shop. This means that a user is subject to credit inquiry at each payment with the prepaid card according to the above-described embodiments. In order to permit only the payment with credit inquiry, a flag indicating whether or not to accept payment without credit inquiry may be added to the card information, and the payment processing device may refer to the card information.

### REFERENCE SIGNS LIST

1 . . . ID management system, 10 . . . ID management device, 11 . . . receiving unit, 12 . . . checking unit, 13 . . . assignment unit, 14 . . . initial setting unit (setting unit, determination unit, changing unit, and evaluation unit), 15 . . . changing unit (determination unit, changing unit, and evaluation unit), 21 . . . card database, 22 . . . pool database, 23 . . . use history database, 30 . . . payment processing device, 40 . . . financial institution server, P . . . ID management program, P10 . . . main module, P11 . . . receiving module, P12 . . . checking module, P13 . . . assignment module, P14 . . . initial setting module, P15 . . . changing module, Ts . . . member shop terminal, Tu . . . user terminal

1-13. (canceled)

14. An information processing system comprising:
a determination unit configured to set a limit amount and a security deposit amount so that the sum of the two amounts does not exceed an amount of advance payment made by a user having applied for a prepaid payment means available at a member shop of a postpaid payment means; and
a changing unit configured to refer to a pool storage unit configured to store a pooled amount to be used for payment for an amount billed for sales from the member shop, the amount billed exceeding a balance of the prepaid payment means, the pooled amount including a security deposit of another user different from the user, and the changing unit being configured to add the security deposit amount set by the determination unit to the pooled amount.

15. The information processing system according to claim 14, wherein
the determination unit determines an additional security deposit amount so that the additional security deposit amount does not exceed the balance of the prepaid payment means, after the prepaid payment means becomes available for the user, and
the changing unit adds the additional security deposit amount to the pooled amount.

16. The information processing system according to claim 14, wherein
based on an amount of advance payment newly made by a user holding a first prepaid payment means and having applied for a second prepaid payment means and a balance and a current security deposit amount of the first prepaid payment means, the determination unit sets a limit amount and a security deposit amount of the second prepaid payment means so that at least a part of the current security deposit amount of the first prepaid payment means is included in the limit amount of the second prepaid payment means, and
the changing unit updates the pooled amount based on a difference between the current security deposit amount of the first prepaid payment means and the security deposit amount of the second prepaid payment means.

17. An information processing method by an information processing system including a processor, comprising:
a determination step of setting a limit amount and a security deposit amount so that the sum of the two amounts does not exceed an amount of advance payment made by a user having applied for a prepaid payment means available at a member shop of a postpaid payment means; and
a changing step of referring to a pool storage unit configured to store a pooled amount and adding the security deposit amount set in the determination step to the pooled amount, the pooled amount being to be used for payment for an amount billed for sales from the member shop, the amount billed exceeding a balance of the prepaid payment means, and the pooled amount including a security deposit of another user different from the user.
